(19) United States
(12) Patent Application Publication
(10) Pub. No.: US 2026/0211790 A1
(43) Pub. Date: Jul. 23, 2026

(54) DETERMINATION SYSTEM AND DETERMINATION METHOD

(71) Applicant: Panasonic Automotive Systems Co., Ltd., Kanagawa (JP)

(72) Inventors: Jumpei OZAKI, Osaka (JP); Daiki OKAZAKI, Kanagawa (JP); Masato TANABE, Kanagawa (JP)

(73) Assignee: Panasonic Automotive Systems Co., Ltd., Kanagawa (JP)

(21) Appl. No.: 19/412,224

(22) Filed: Dec. 8, 2025

(30) Foreign Application Priority Data
Jan. 17, 2025 (JP) 2025-007190

(51) Int. Cl. G06F 11/34

(52) U.S. Cl. CPC G06F 11/3476; G06F 11/3447

(57) ABSTRACT

A determination system includes: a log obtainer that obtains log information; a preprocessor that generates preprocessed log information from the log information; a primary analyzer that generates primary determination result information by performing primary analysis on the preprocessed log information; a prompt generator that generates a prompt for generative artificial intelligence (AI) based on the preprocessed log information; a secondary analyzer that performs, as secondary analysis, a process of obtaining secondary determination result information by inputting the prompt to the generative AI; an overall determiner that generates overall determination result information based on the primary determination result information and the secondary determination result information; and an outputter that outputs a determination result report that includes a determination result indicated by the overall determination result information.

### CROSS REFERENCE TO RELATED APPLICATION

The present application is based on and claims priority of Japanese Patent Application No. 2025-007190 filed on January 17, 2025.

### Field

The present disclosure relates to a system or the like that performs determination related to a result of a security test.

### Background

In recent years, functions provided by automobiles have been rapidly evolving. Such functions include, for example, external connectivity, autonomous driving, automated control, in-vehicle infotainment (IVI), and the like. Furthermore, due to the evolution of such functions, the integration of electronic control units (ECUs), and the implementation of software defined vehicles (SDVs), measures to handle security risks for automobiles have become increasingly important. In particular, it has become increasingly important to verify security and to perform validation for automobiles that are provided with a variety of different interfaces during the final verification stage before such automobiles or in-vehicle devices are shipped. The act of validation is also referred to as a security test, and such a test involves verifying whether sufficient measures have been taken to handle threats and verifying whether any vulnerabilities exist.

A fuzzing test is a type of a security test. A fuzzing test is a test in which invalid input data or unexpected input data is input to an evaluation target device, such as the above-mentioned in-vehicle devices and the like, and anomalous operations and vulnerabilities in the evaluation target device are detected. It should be noted that such input data is also referred to as fuzzing data or fuzz data. By inputting fuzzing data, there is a risk that the evaluation target device may be caused to crash. By inputting fuzzing data, the evaluation target device may be reset or may freeze up, for example. Accordingly, there is a need to perform a fuzzing test before the evaluation target device is shipped.

A determination result of a fuzzing test for an evaluation target device is typically determined by visually checking whether a crash has occurred or by checking whether the evaluation target device is responsive. However, in recent years, there have been attempts to implement machine learning in order to reduce the number of man-hours needed to perform fuzzing tests. Patent Literature (PTL) 1 discloses an anomaly determination device that uses machine learning.

### Citation List

### Patent Literature

PTL 1: WO 2022/249315

### SUMMARY

However, the anomaly determination device disclosed in the above-mentioned PTL 1 can be improved upon.

In view of this, the present disclosure provides a determination system and the like that are capable of further improving upon the above related art.

A determination system according to one aspect of the present disclosure includes: a log obtainer that obtains log information indicating an execution status of a security test performed on an evaluation target device; a setting obtainer that obtains a user setting file that is set by a user, and outputs setting information based on the user setting file; a preprocessor that generates preprocessed log information by performing an edit on the log information as preprocessing; a primary analyzer that generates primary determination result information indicating a determination result of the security test by performing primary analysis on the preprocessed log information using the setting information; a prompt generator that generates, based on the setting information and the preprocessed log information, a prompt that prompts generative artificial intelligence (AI) to output a determination result of the security test; a secondary analyzer that performs, as secondary analysis, a process of obtaining secondary determination result information indicating a determination result of the security test by inputting the prompt to the generative AI; an overall determiner that generates overall determination result information indicating an overall determination result of the security test, based on the determination result indicated by the primary determination result information and the determination result indicated by the secondary determination result information; and an outputter that outputs a determination result report that includes the overall determination result indicated by the overall determination result information.

It should be noted that these generic and specific aspects may be implemented as a device, a method, an integrated circuit, a computer program, or a computer-readable recording medium such as a CD-ROM, or may be implemented as any combination of a device, a method, an integrated circuit, a computer program, and a recording medium. Furthermore, the recording medium may be a non-transitory recording medium.

The determination system according to the present disclosure is capable of properly determining a result of a security test performed on an evaluation target device, and a further improvement can be achieved.

Additional benefits and advantages in one aspect of the present disclosure will become apparent from the specification and the drawings. While such benefits and advantages are yielded by configurations of embodiments and configurations described in the specification and the drawings, not all configurations are necessary.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an example of a configuration of a determination system according to an embodiment.

FIG. 2 is a diagram for describing processing performed by a setting obtainer according to the embodiment.

FIG. 3 is a diagram for describing processing performed by a preprocessor according to the embodiment.

FIG. 4 is a diagram illustrating an example of a prompt that is generated by a prompt generator according to the embodiment and is provided as output.

FIG. 5 is a diagram for describing processing performed by an overall determiner using primary determination result information and secondary determination result information according to the embodiment.

FIG. 6 is a diagram illustrating an example of a determination result report according to the embodiment.

FIG. 7 is a sequence diagram illustrating an example of processing operations of the determination system according to the embodiment.

FIG. 8 is a flowchart illustrating an example of processing operations of the determination system according to the embodiment.

### DESCRIPTION OF EMBODIMENT

### Underlying Knowledge Forming Basis of the Present Disclosure

In relation to the anomaly determination device according to PTL 1 described in the “Background Art” section, the inventors have found the following issues to be problematic.

The anomaly determination device according to PTL 1 determines whether an anomaly is present in a test target device that is a device subject to a security test performed using an inspection device. Specifically, the anomaly determination device receives a pre-classified information group that is output by a plurality of monitoring functions of the inspection device, and outputs a detection result by performing an anomaly classification process and an anomaly detection process on the pre-classified information group. In the anomaly classification process, the anomaly determination device classifies information in the pre-classified information group into normal information items and anomalous information items using a machine learning algorithm, and handles the plurality of information items that have been classified as anomalous as an anomalous information group. In the anomaly detection process, the anomaly determination device identifies relationships between the plurality of anomalous information items included in the anomalous information group and the plurality of monitoring functions of the inspection device, and derives anomaly identification values by performing weighting on the monitoring functions identified. Then, the anomaly determination device compares an anomaly identification value and a predetermined threshold value, and when the anomaly identification value is greater than or equal to the threshold value, the anomaly determination device determines that an anomaly is present in the test target device.

In this manner, the anomaly determination device according to PTL 1 uses a machine learning algorithm. However, in order to use such an algorithm, it is necessary to perform machine learning that is specific to the test target device in advance. In other words, it is necessary to sufficiently accumulate past data on the test target device and knowhow, such as the determination criteria used in past security tests, and to use such information for machine learning. Furthermore, it is difficult to apply a machine learning model that has been specifically built for a given test target device on test target devices that have a structure that is different from the given test target device. Accordingly, it is necessary to accumulate past data and knowhow, such as the determination criteria used in past security tests for the other test target devices as well. Consequently, it is problematic that the results of such security tests cannot be properly determined if such knowhow is not sufficiently obtained. Furthermore, in machine learning algorithms, there are cases in which the accuracy of determination results of such security tests is low.

In view of this, a determination system according to a first aspect of the present disclosure includes: a log obtainer that obtains log information indicating an execution status of a security test performed on an evaluation target device; a setting obtainer that obtains a user setting file that is set by a user, and outputs setting information based on the user setting file; a preprocessor that generates preprocessed log information by performing an edit on the log information as preprocessing; a primary analyzer that generates primary determination result information indicating a determination result of the security test by performing primary analysis on the preprocessed log information using the setting information; a prompt generator that generates, based on the setting information and the preprocessed log information, a prompt that prompts generative artificial intelligence (AI) to output a determination result of the security test; a secondary analyzer that performs, as secondary analysis, a process of obtaining secondary determination result information indicating a determination result of the security test by inputting the prompt to the generative AI; an overall determiner that generates overall determination result information indicating an overall determination result of the security test, based on the determination result indicated by the primary determination result information and the determination result indicated by the secondary determination result information; and an outputter that outputs a determination result report that includes the overall determination result indicated by the overall determination result information. It should be noted that a fuzzing test is a specific example of a security test.

Accordingly, primary determination result information that indicates an accurate determination result can be generated by performing primary analysis, and it is also possible to achieve a sophisticated level of analysis and generate secondary determination result information that indicates a determination result that is highly accurate by performing secondary analysis. Furthermore, in the first aspect, a determination result report is output that includes an overall determination result of the security test that is based on results of primary analysis and secondary analysis. Consequently, it is possible to enhance the accuracy and reliability of a determination result included in the determination result report to be higher than that of a determination result for primary analysis for error words and the like, and higher than that of a determination result for secondary analysis using generative AI, for example. Furthermore, since the log information is used, it is possible to increase the likelihood of effectively identifying and preemptively preventing potential failures that are related to the security of the evaluation target device. Furthermore, since the determination result report is automatically output and the determination result report can be promptly output, it is possible to reduce the amount of man-hours needed to determine the results of the security test. Furthermore, even for a user who lacks specialized knowledge, the user can easily grasp the content of a determination result of a security test by looking at the determination result report. Furthermore, since generative AI is used to determine a result of the security test, it is possible to reduce the necessity to perform machine learning that corresponds to the evaluation target device in advance of the security test, thereby allowing a determination result of the security test to be obtained in an efficient manner. Consequently, with the first aspect, a result of a security test performed on the evaluation target device can be properly determined.

In other words, in the anomaly determination device according to the above-mentioned PTL 1, it is problematic that it is difficult to properly determine a result of a security test performed on an evaluation target device. In contrast, the determination system and the like provided in the present disclosure are capable of properly determining a result of a security test performed on an evaluation target device.

Furthermore, a determination system according to a second aspect of the present disclosure is a determination system in which the preprocessing may include deleting or converting at least one of a character, a word, or a row included in the log information. It should be noted that the second aspect may be dependent on the first aspect.

Accordingly, by performing preprocessing, characters, such as garbled or corrupted text included in the log information are deleted, and characters, such as those that are susceptible to being misidentified are converted into characters that are not susceptible to being misidentified, for example. Since preprocessed log information that is generated in such preprocessing is used in each of the processes performed by the primary analyzer and the prompt generator, as well as the generative AI, it is possible to reduce the possibility of such processes being executed in an improper manner. Furthermore, when a word, such as one that is equivalent to confidential information is converted to a different word, it is possible to protect such confidential information and privacy in general. Furthermore, when the character count is being limited through the deletion of characters and the like, it is possible to reduce the processing burden placed on the primary analyzer, the prompt generator, the generative AI, and the like.

Furthermore, a determination system according to a third aspect of the present disclosure is a determination system in which the preprocessing may include a process of detecting, in the log information, a word indicated in the setting information, and extracting, from the log information, a portion consisting of a plurality of consecutive rows and including the word detected. It should be noted that the third aspect may be dependent on the first aspect or the second aspect.

Accordingly, since portions that are important for determining a result of the security test are extracted from the log information, by preprocessing, and included in the preprocessed log information, it is possible to reduce the processing burden placed on the primary analyzer and the prompt generator, which use the preprocessed log information, as well as the generative AI and the like.

Furthermore, a determination system according to a fourth aspect of the present disclosure is a determination system in which the preprocessing may include a process of extracting, from the log information, only a portion of information that is output within a specified period of time during the security test. It should be noted that the fourth aspect may be dependent on any one of the first aspect to the third aspect. For example, the specified period of time may be included in the setting information.

Accordingly, only those portions that correspond to the specified period of time are extracted from the log information, by preprocessing, and included in the preprocessed log information. Consequently, it is possible to reduce the processing burden placed on the primary analyzer and the prompt generator, which use the preprocessed log information, as well as the generative AI and the like.

Furthermore, a determination system according to a fifth aspect of the present disclosure is a determination system in which the primary analyzer may generate the primary determination result information by searching the preprocessed log information for an error word indicated in the setting information. It should be noted that the fifth aspect may be dependent on any one of the first aspect to the fourth aspect.

Accordingly, it is possible to generate primary determination result information that indicates a proper determination result of the security test.

Furthermore, a determination method according to a first aspect of the present disclosure includes: obtaining log information indicating an execution status of a security test performed on an evaluation target device; obtaining a user setting file that is set by a user, and outputting setting information based on the user setting file; generating preprocessed log information by performing an edit on the log information as preprocessing; generating primary determination result information indicating a determination result of the security test by performing primary analysis on the preprocessed log information using the setting information; generating, based on the setting information and the preprocessed log information, a prompt that prompts generative artificial intelligence (AI) to output a determination result of the security test; performing, as secondary analysis, a process of obtaining secondary determination result information indicating a determination result of the security test by inputting the prompt to the generative AI; generating overall determination result information indicating an overall determination result of the security test, based on the determination result indicated by the primary determination result information and the determination result indicated by the secondary determination result information; and outputting a determination result report that includes the overall determination result indicated by the overall determination result information.

Accordingly, the same advantageous effects as the determination system according to the first aspect are achieved.

Hereinafter, an exemplary embodiment will be specifically described with reference to the drawings.

It should be noted that the embodiment described below merely illustrates general or specific examples of the present disclosure. The numerical values, shapes, materials, elements, the arrangement and connection of the elements, steps, the order of the steps, etc., described in the following embodiment are mere examples, and are therefore not intended to limit the present disclosure. Accordingly, among elements in the following embodiment, those not appearing in any of the independent claims that indicate the broadest concepts of the present disclosure will be described as optional elements.

It should be noted that the figures are schematic diagrams and are not necessarily precise illustrations. In the figures, substantially same elements are given the same reference numbers.

### Embodiment

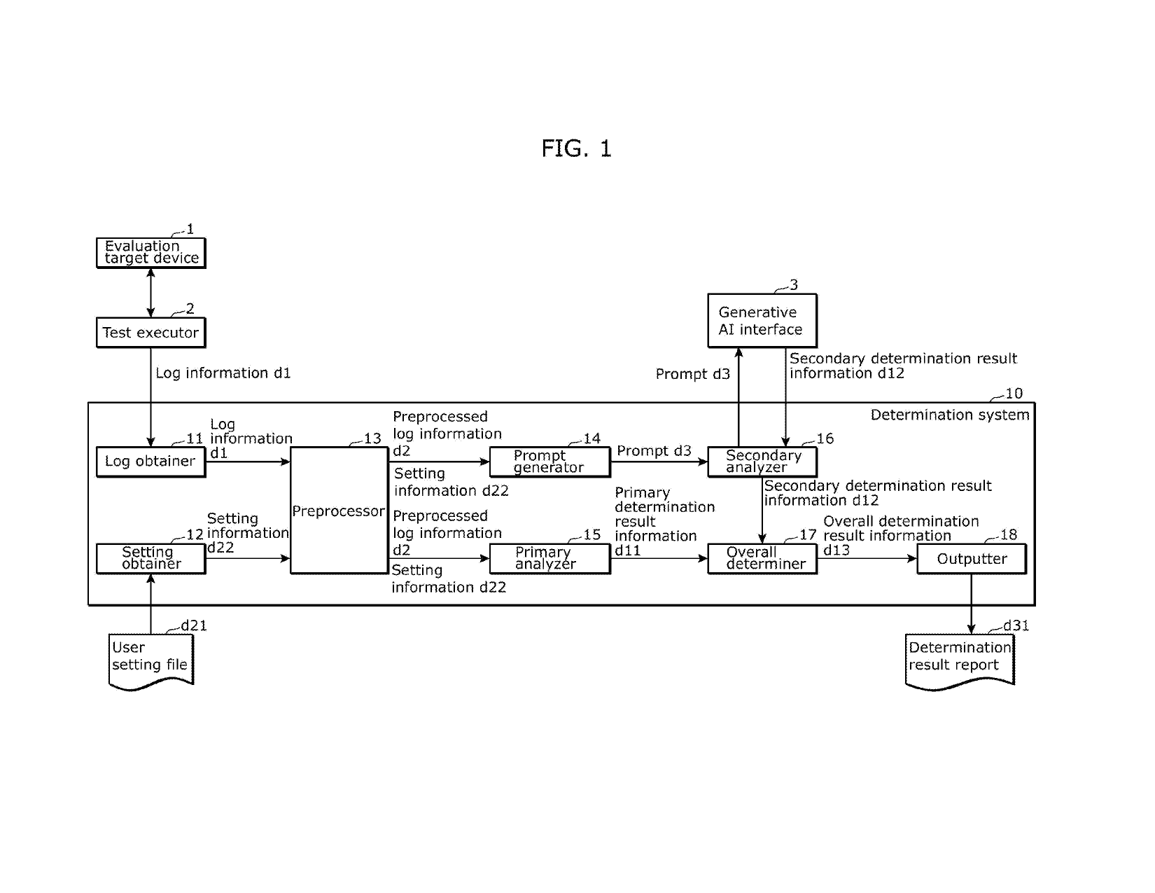

FIG. 1 is a diagram illustrating an example of a configuration of a determination system according to the present embodiment.

Determination system 10 according to the present embodiment is a system that properly determines a result of a security test of evaluation target device 1, and includes log obtainer 11, setting obtainer 12, preprocessor 13, prompt generator 14, primary analyzer 15, secondary analyzer 16, overall determiner 17, and outputter 18. Although a specific example of the security test in the present embodiment is a fuzzing test, the security test may be some other test.

Log obtainer 11 obtains log information d1 indicating an execution status of a fuzzing test performed on evaluation target device 1. The fuzzing test is performed by test executor 2. Test executor 2 performs the fuzzing test on evaluation target device 1, and outputs log information d1 that indicates the execution status to log obtainer 11. For example, by inputting fuzzing data to evaluation target device 1, as input data, test executor 2 not only obtains, as log information d1, information that is ultimately output from evaluation target device 1, but also obtains information that is based on the fuzzing data and internal processes of evaluation target device 1. Log obtainer 11 obtains log information d1 from test executor 2, and outputs log information d1 to preprocessor 13. It should be noted that evaluation target device 1 may, for example, be an in-vehicle information device, and may be an electronic control unit (ECU) or the like. Furthermore, the method by which test executor 2 and log obtainer 11 collect log information d1 may be different depending on the type, structure, and operating system (OS) that is installed in evaluation target device 1.

Setting obtainer 12 obtains user setting file d21 that is set by a user, and outputs setting information d22 based on user setting file d21. User setting file d21 includes user setting information related to evaluation target device 1 and the fuzzing test. Setting information d22 is, for example, information that includes the user setting information and other information. Next, setting obtainer 12 outputs setting information d22 to preprocessor 13.

Preprocessor 13 obtains log information d1 from log obtainer 11, and obtains setting information d22 from setting obtainer 12. Next, preprocessor 13 generates preprocessed log information d2 by performing an edit on log information d1 as preprocessing. Here, preprocessor 13 may perform the preprocessing based on setting information d22. Next, preprocessor 13 outputs preprocessed log information d2 and setting information d22 to prompt generator 14 and primary analyzer 15.

Prompt generator 14 obtains preprocessed log information d2 and setting information d22 from preprocessor 13. Next, based on the above-mentioned preprocessed log information d2 and setting information d22, prompt generator 14 generates prompt d3 that prompts generative artificial intelligence (AI) to output a determination result of the fuzzing test. Prompt generator 14 outputs prompt d3 that is generated to secondary analyzer 16. It should be noted that the determination result of the fuzzing test is a result of determination performed on a result of the fuzzing test, and indicates, for example, whether evaluation target device 1 is in a normal state, whether a minor issue is occurring in evaluation target device 1, whether a critical error is occurring in evaluation target device 1, or the like.

Primary analyzer 15 obtains preprocessed log information d2 and setting information d22 from preprocessor 13. Next, primary analyzer 15 performs primary analysis on preprocessed log information d2 based on setting information d22. Stated differently, primary analyzer 15 performs primary analysis on preprocessed log information d2 using setting information d22. By performing primary analysis, primary analyzer 15 generates primary determination result information d11 indicating a determination result of the fuzzing test, and outputs primary determination result information d11 to overall determiner 17.

Secondary analyzer 16 obtains prompt d3 from prompt generator 14. Next, secondary analyzer 16 performs secondary analysis. Secondary analysis is a process in which secondary determination result information d12 indicating the determination result of the fuzzing test is obtained by inputting prompt d3 to the generative AI. Specifically, secondary analyzer 16 outputs prompt d3 to generative AI interface 3, and obtains secondary determination result information d12 from generative AI interface 3. Secondary analyzer 16 outputs secondary determination result information d12 to overall determiner 17.

Overall determiner 17 obtains primary determination result information d11 from primary analyzer 15, and obtains secondary determination result information d12 from secondary analyzer 16. Next, overall determiner 17 generates overall determination result information d13 indicating an overall determination result of the fuzzing test based on the determination result indicated by primary determination result information d11 and the determination result indicated by secondary determination result information d12. Overall determiner 17 outputs overall determination result information d13 to outputter 18.

Outputter 18 obtains overall determination result information d13 from overall determiner 17. Next, outputter 18 generates and outputs determination result report d31 that includes the determination result that is indicated by overall determination result information d13.

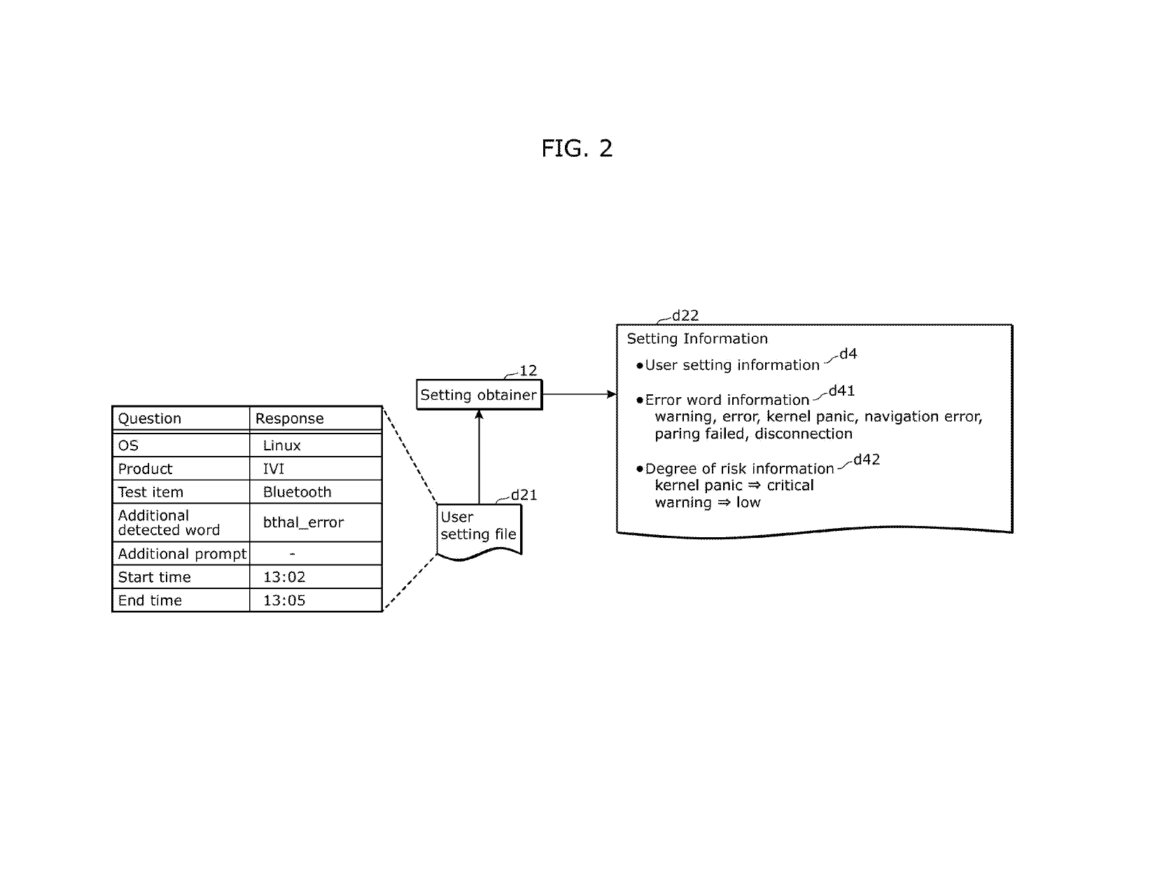

FIG. 2 is a diagram for describing processing performed by setting obtainer 12 according to the embodiment.

Setting obtainer 12 obtains user setting file d21 shown in FIG. 2, for example. Such a user setting file d21 is obtained in the form of a series of questions. For example, setting obtainer 12 presents the user with a plurality of questions via a user interface that includes a display and an input device. It should be noted that the input device may be a keyboard, a mouse, a touch pad, or the like. Each of the plurality of questions is, for example, related to an operating system (OS), a product, a test item, an additional detected word, an additional prompt, a start time, an end time, and the like. The user responds to the questions by performing an input operation on the input device.

For example, for a question on the OS, the user responds with the name of the OS installed in evaluation target device 1 (“Linux (registered trademark)”, for example), and for a question on the product, the user responds with a type, name, or collective name of evaluation target device 1 (“in-vehicle infotainment (IVI)”, for example). Furthermore, for a question on the test item, the user responds with content of the fuzzing test or a specific target item (“Bluetooth (registered trademark)”, for example). Furthermore, for a question on the additional detected word, the user responds with an error word (“bthal_error”, for example) that is further added to the one or more default error words. Furthermore, for a question on the start time, the user responds with “13:02”, for example, and for a question on the end time, the user responds with “13:05”, for example. The period of time from the start time to the end time is the period of time during which the information used to determine the result of the fuzzing test, among the information in log information d1, is output.

When setting obtainer 12 obtains such a user setting file d21, setting obtainer 12 generates and outputs setting information d22 that is shown in FIG. 2, for example. Setting information d22 includes user setting information d4, error word information d41, and degree of risk information d42. Setting obtainer 12 extracts a plurality of responses excluding the response on the additional detected word among the plurality of responses shown in user setting file d21, for example, and generates user setting information d4 that includes the plurality of responses extracted. Furthermore, by adding the additional detected word provided in the response as an error word to the one or more default error words, setting obtainer 12 generates error word information d41 that includes a plurality of error words. The one or more default error words may be selected in accordance with user setting information d4.

Next, by adding degree of risk information d42 to user setting information d4 and error word information d41 that have been generated, setting obtainer 12 generates setting information d22. Degree of risk information d42 is information that indicates degrees of risk of error words indicated in error word information d41. For example, in degree of risk information d42, “critical” is indicated as the degree of risk of the error word “kernel panic” and “low” is indicated as the degree of risk of the error word “warning”. It should be noted that “critical” is, for example, the highest degree of risk, and “low” is a degree of risk that is lower than “critical”.

In this manner, in the present embodiment, the information necessary for primary analysis can be customized by using user setting information d4. Furthermore, characteristics and specifications of evaluation target device 1 may be applied to determine the result of the fuzzing test. Furthermore, prompt d3 can be fine-tuned.

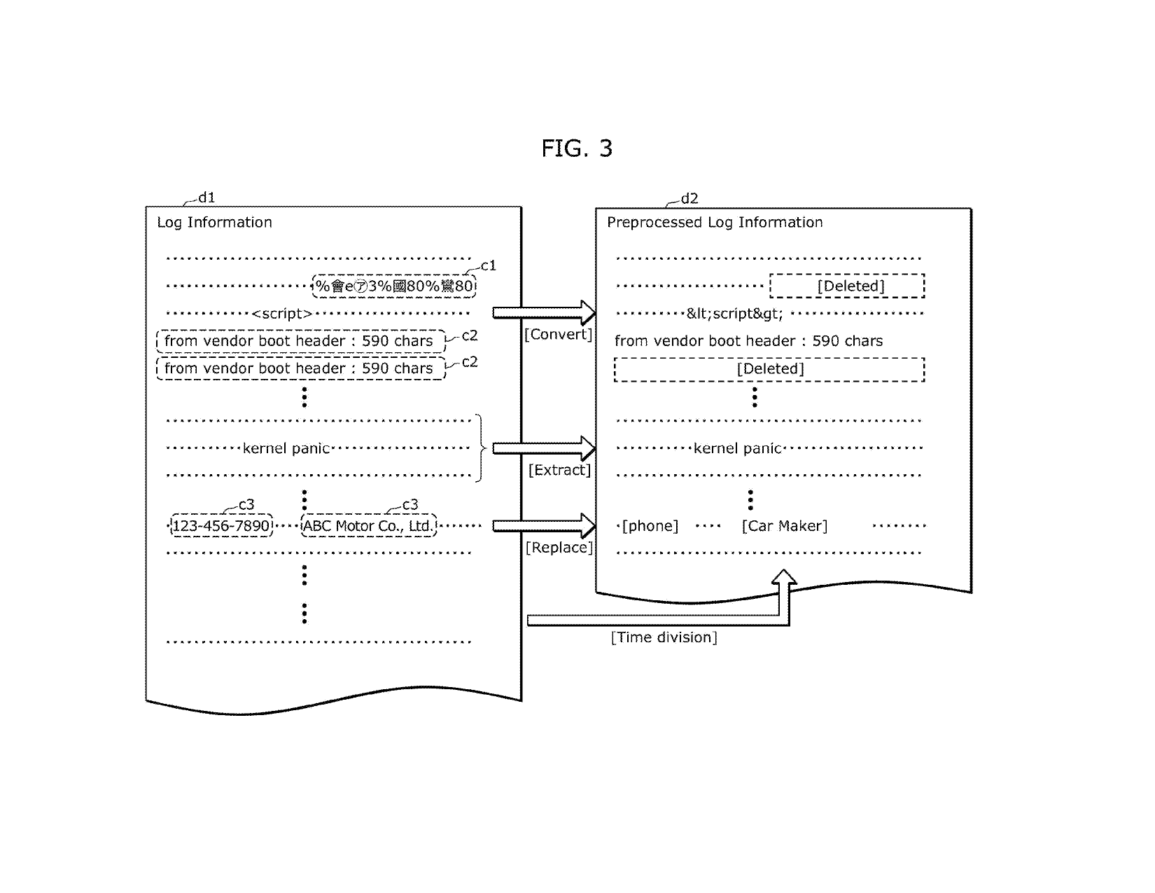

FIG. 3 is a diagram for describing processing performed by preprocessor 13 according to the embodiment.

Preprocessor 13 performs preprocessing on log information d1 shown in FIG. 3. For example, preprocessor 13 performs each of a character encoding handling process, an escape process, a character count reduction process, a word detection process, a privacy protection process, and a time division process as preprocessing.

In the character encoding handling process, preprocessor 13 deletes character string c1 that is a segment of garbled or corrupted text that is included in log information d1. Accordingly, errors in the generative AI resulting from character string c1 can be prevented. Furthermore, in the escape process, preprocessor 13 converts data (characters, for example) to other forms of data in order to prevent the data included in log information d1 from being falsely recognized. As a specific example, for the character string “<script>” included in log information d1, preprocessor 13 converts character data “<” to “&lt;” and converts character data “>” to “&gt;”.

In the character count reduction process, preprocessor 13 performs a process in accordance with a character count limit of prompt d3 that is to be input to the generative AI. For example, of a plurality of rows c2 that are included in log information d1 and are redundant with each other, preprocessor 13 deletes one or more rows c2 such that only one row c2 remains. It should be noted that the plurality of redundant rows c2 need not be completely identical and may be substantially identical instead. Furthermore, the plurality of redundant rows c2 need not be consecutive.

In the privacy protection process, preprocessor 13 detects protected character strings c3, which are character strings related to privacy or confidential information, in log information d1, and deletes or replaces protected character strings c3. For example, preprocessor 13 detects each of phone number “123-456-7890” and company name “ABC Motor Co., Ltd.” as protected character strings c3. Next, preprocessor 13 replaces phone number “123-456-7890”, which is a protected character string c3, with “[phone]” and replaces company name “ABC Motor Co., Ltd.”, which is a protected character string c3, with “[Car Maker]”.

In this manner, the preprocessing according to the present embodiment includes deleting or converting at least one of a character, a word, or a row included in log information d1.

In the word detection process, for example, in log information d1, preprocessor 13 detects an error word included in error word information d41 indicated in setting information d22. Next, preprocessor 13 extracts rows that include the error word and one or more rows in a vicinity of the rows extracted from log information d1. In other words, the preprocessing according to the present embodiment includes a process of detecting, in log information d1, the error word indicated in setting information d22, and extracting, from log information d1, a portion consisting of a plurality of consecutive rows and including the error word detected.

In the time division process, information preprocessor 13 extracts, from log information d1, only a portion of information that is output from evaluation target device 1 within a period of time that is specified by the user. For example, preprocessor 13 identifies a period of time from the start time to the end time indicated in user setting information d4 as the period of time that is specified by the user, and extracts the portion corresponding to the period of time. In other words, the preprocessing according to the present embodiment includes a process of extracting, from log information d1, only a portion of information that is output within a specified period of time during the fuzzing test.

By performing these processes as preprocessing, preprocessor 13 generates preprocessed log information d2. Note that preprocessor 13 need not perform all of the character encoding handling process, the escape process, the character count reduction process, the word detection process, the privacy protection process, and the time division process, and need only perform at least one of these processes.

When such a preprocessed log information d2 and setting information d22 are obtained, primary analyzer 15 performs primary analysis on preprocessed log information d2 based on setting information d22. For example, primary analyzer 15 searches for the error words in preprocessed log information d2 for each error word included in error word information d41 of setting information d22. In other words, primary analyzer 15 detects the error words in preprocessed log information d2. Next, primary analyzer 15 identifies degrees of risk of error words that have been searched for in preprocessed log information d2 based on degree of risk information d42 of setting information d22. Furthermore, for each degree of risk, primary analyzer 15 derives a frequency of occurrence, in preprocessed log information d2, of error words that are classified as being associated with the degree of risk. For example, primary analyzer 15 derives a first frequency of occurrence that is a frequency of occurrence of an error word (“kernel panic”, for example) classified as having a degree of risk of “critical”, and derives a second frequency of occurrence that is a frequency of occurrence of an error word (“warning”, for example) classified as having a degree of risk of “low”.

Moreover, the higher that at least one of the first frequency of occurrence or the second frequency of occurrence is, the higher the probability that the determination result of the fuzzing test that corresponds to preprocessed log information d2 is determined by primary analyzer 15 to be a “FAIL” result. Conversely, the lower that at least one of the first frequency of occurrence or the second frequency of occurrence is, the higher the probability that the determination result of the fuzzing test that corresponds to preprocessed log information d2 is determined by primary analyzer 15 to be a “PASS” result. As a specific example, when the first frequency of occurrence is greater than or equal to a first threshold value, primary analyzer 15 determines the determination result of the fuzzing test to be a “FAIL” result. Next, when the first frequency of occurrence is less than the first threshold value and the second frequency of occurrence is greater than or equal to a second threshold value, primary analyzer 15 determines the determination result of the fuzzing test to be a “WARNING” result. Furthermore, when the first frequency of occurrence is less than the first threshold value and the second frequency of occurrence is less that the second threshold value, primary analyzer 15 determines the determination result of the fuzzing test to be a “PASS” result. Primary analyzer 15 outputs primary determination result information d11 that indicates a determination result that is determined in this manner.

In this manner, primary analyzer 15 according to the present embodiment generates primary determination result information d11 by searching preprocessed log information d2 for an error word indicated in setting information d22.

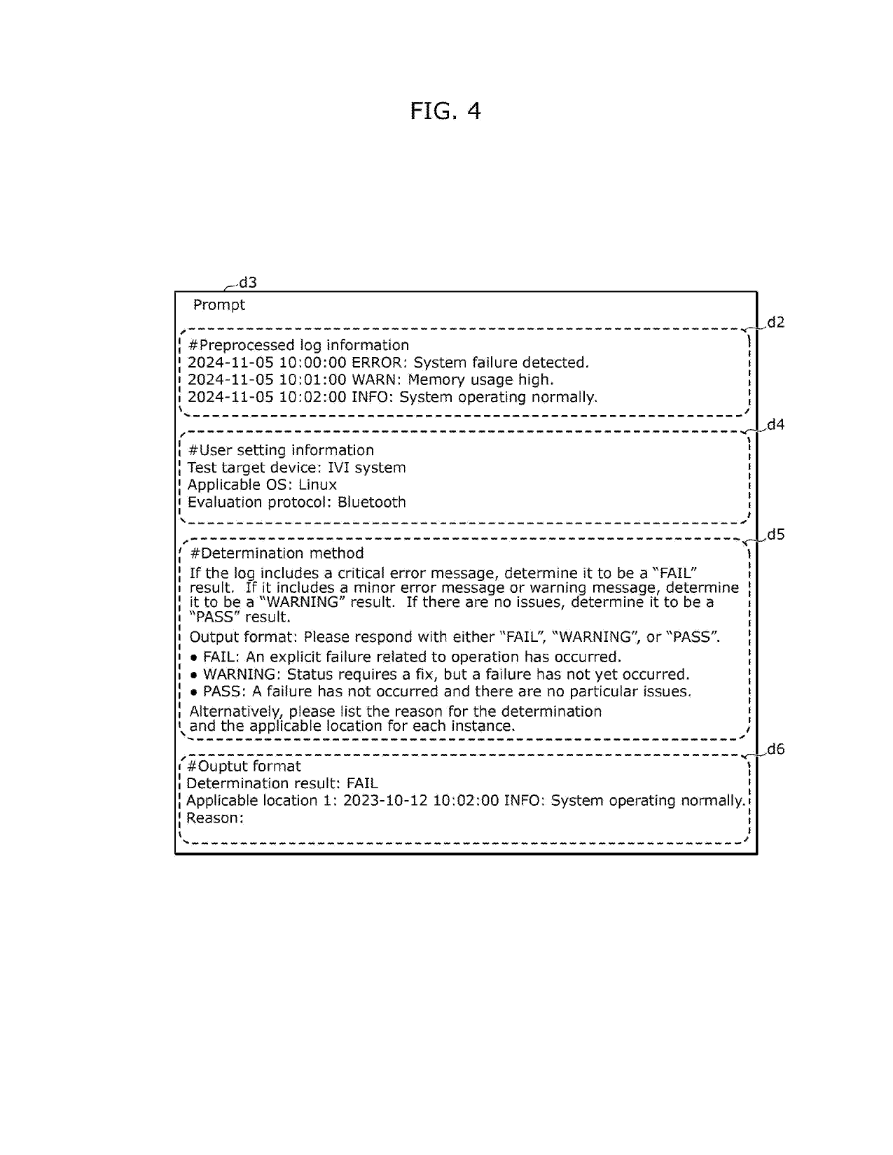

FIG. 4 is a diagram illustrating an example of prompt d3 that is generated by prompt generator 14 according to the embodiment and is provided as output.

Prompt generator 14 generates prompt d3 shown in FIG. 4, for example. Prompt d3 includes preprocessed log information d2, user setting information d4, determination method d5, and output format d6.

User setting information d4 is information included in setting information d22. An additional prompt included in user setting file d21 may be included in user setting information d4. Determination method d5 is a method that the generative AI uses to determine a result of the fuzzing test. In determination method d5, for example, it is indicated that when the log (i.e., preprocessed log information d2) includes a critical error message, a “FAIL” result is determined. When the log includes a minor error or warning message, a “WARNING” result is determined. Finally, when there are no issues, a “PASS” result is determined. It should be noted that in determination method d5, messages are included that prompt the generative AI to provide a reason why a “FAIL”, “WARNING”, or “PASS” result was determined (i.e., determination reason) and a location that acts as the basis of the reason (applicable location in preprocessed log information d2, for example). Output format d6 is information for specifying the format of information output from the generative AI. In other words, in output format d6, the format for secondary determination result information d12 is provided as a specific sample.

Once secondary analyzer 16 obtains a prompt d3 that has been generated in such a manner from prompt generator 14, secondary analyzer 16 then outputs prompt d3 to generative AI interface 3. Generative AI interface 3 is an application programming interface (API) for inputting prompt d3 to the generative AI and for receiving a response from the generative AI as secondary determination result information d12. As a result, secondary analyzer 16 obtains a response to prompt d3, or in other words secondary determination result information d12, from the generative AI via generative AI interface 3. Secondary determination result information d12 is output from the generative AI and indicates a determination result of the fuzzing test that corresponds to prompt d3, or in other words, a “FAIL”, a “WARNING”, or a “PASS” result, a determination reason, and an applicable location. Next, secondary analyzer 16 outputs secondary determination result information d12 that includes the determination results and the like to overall determiner 17.

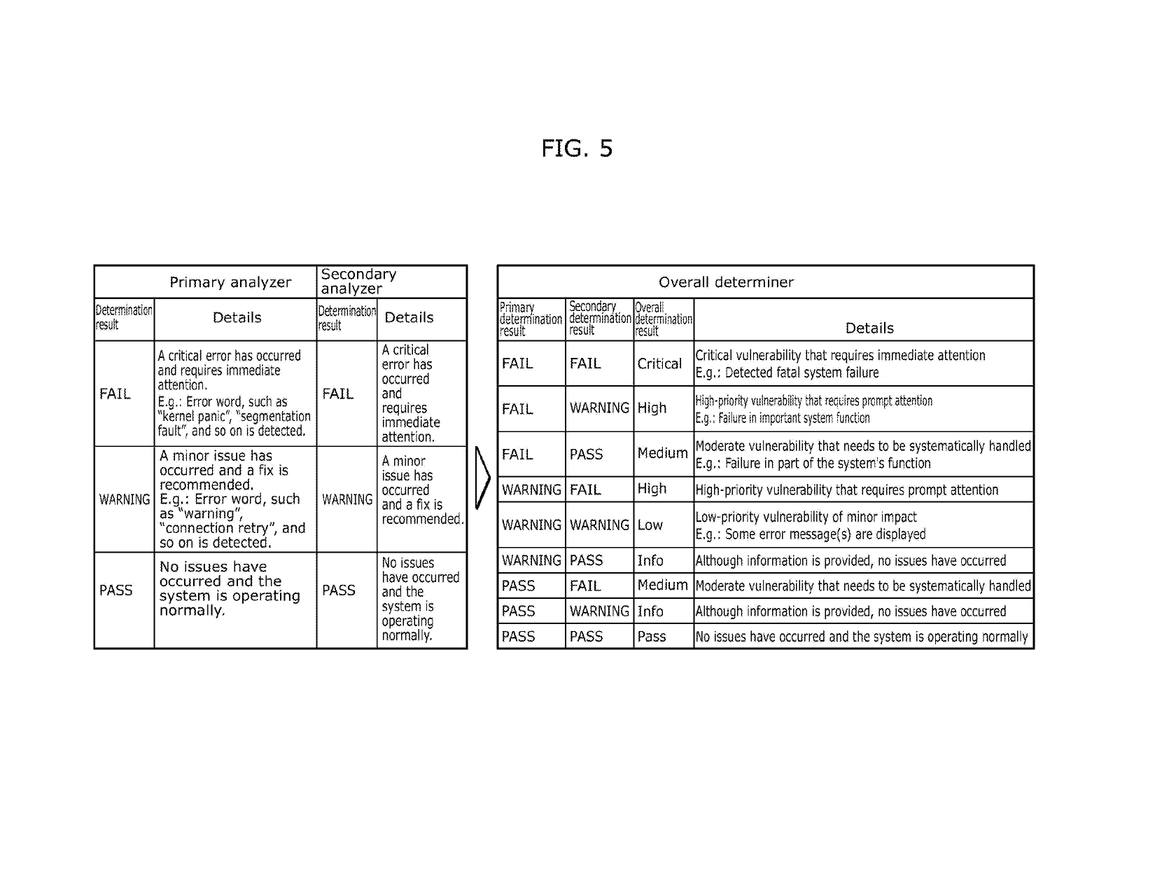

FIG. 5 is a diagram for describing processing performed by overall determiner 17 using primary determination result information d11 and secondary determination result information d12 according to the embodiment.

Primary analyzer 15 outputs primary determination result information d11 indicating a “FAIL”, a “WARNING”, or a “PASS” result as a determination result. In the same manner, secondary analyzer 16 outputs secondary determination result information d12 indicating a “FAIL”, a “WARNING”, or a “PASS” result as a determination result.

It should be noted that “FAIL” indicates, for example, that a critical error has occurred and requires immediate attention. For example, when primary analyzer 15 detects an error word that is classified as “critical”, such as “kernel panic”, “segmentation fault”, or the like, primary analyzer 15 determines the determination result of the fuzzing test to be a “FAIL” result. “WARNING” indicates, for example, that a minor issue has occurred and a fix is recommended. For example, when primary analyzer 15 detects an error word that is classified as “low”, such as “warning”, “connection retry”, or the like, primary analyzer 15 determines the determination result of the fuzzing test to be a “WARNING” result. “PASS” indicates, for example, that no issues have occurred and the system is operating normally. For example, when primary analyzer 15 does not detect any error words that are classified as “critical” or “low”, primary analyzer 15 determines the determination result of the fuzzing test to be a “PASS” result.

Overall determiner 17 determines an overall determination result with respect to a combination of the determination result indicated in primary determination result information d11 (i.e., primary determination result) and the determination result indicated in secondary determination result information d12 (i.e., secondary determination result). The overall determination result is an overall determination result for the primary determination result and the secondary determination result, and can also be said to indicate a degree of importance with which measures should be taken for evaluation target device 1. Specifically, such an overall determination result can be indicated as one of a plurality of different levels. The plurality of levels includes “Critical”, “High”, “Medium”, “Low”, “Info”, and “Pass”. The degree of importance decreases in descending order from “Critical” to “High” to “Medium” to “Low” to “Info” to “Pass”. It should be noted that the degree of importance can also be described as a priority level with which measures should be taken for evaluation target device 1.

For example, for a combination of a “FAIL” result in the primary determination result and a “FAIL” result in the secondary determination result, overall determiner 17 determines the overall determination result to be a “Critical” result. Furthermore, for a combination of a “FAIL” result in the primary determination result and a “WARNING” result in the secondary determination result, or a combination of a “WARNING” result in the primary determination result and a “FAIL” result in the secondary determination result, overall determiner 17 determines the overall determination result to be a “High” result. Furthermore, for a combination of a “FAIL” result in the primary determination result and a “PASS” result in the secondary determination result, or a combination of a “PASS” result in the primary determination result and a “FAIL” result in the secondary determination result, overall determiner 17 determines the overall determination result to be a “Medium” result. Furthermore, for a combination of a “WARNING” result in the primary determination result and a “WARNING” result in the secondary determination result, overall determiner 17 determines the overall determination result to be a “Low” result. Furthermore, for a combination of a “WARNING” result in the primary determination result and a “PASS” result in the secondary determination result, or a combination of a “PASS” result in the primary determination result and a “WARNING” result in the secondary determination result, overall determiner 17 determines the overall determination result to be an “Info” result. Furthermore, for a combination of a “PASS” result in the primary determination result and a “PASS” result in the secondary determination result, overall determiner 17 determines the overall determination result to be a “Pass” result.

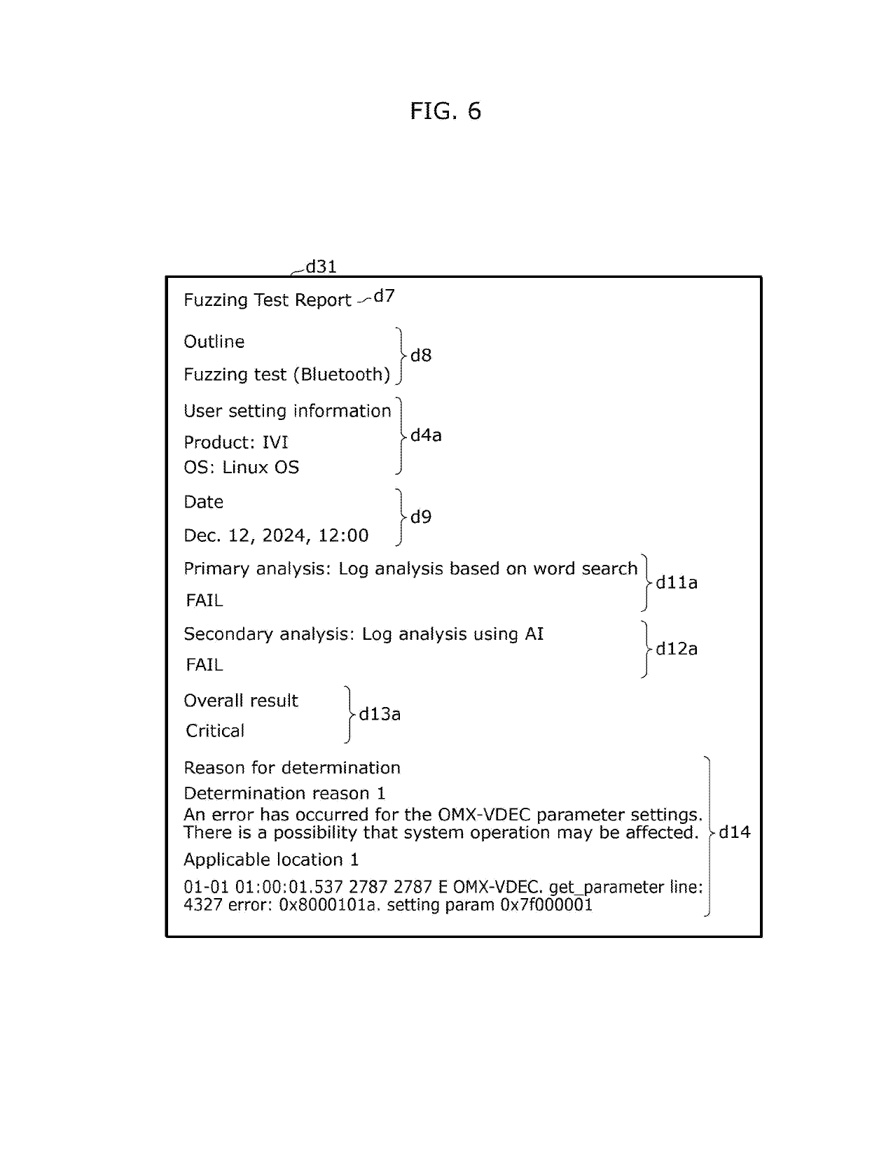

FIG. 6 is a diagram illustrating an example of determination result report d31 according to the present embodiment.

For example, as illustrated in FIG. 6, determination result report d31 includes title d7, outline d8, user setting information d4a, date d9, primary determination result d11a, secondary determination result d12a, overall result d13a, and determination reason d14. For example, title d7 is “Fuzzing Test Report”. Outline d8 includes the objective, an outline, and the like of the fuzzing test, and is, for example, “Fuzzing test (Bluetooth)”. User setting information d4a is information indicating the type, OS, protocol, and the like of evaluation target device 1 that is included in user setting information d4 of setting information d22, and indicates “Product: IVI” and “OS: Linux OS”, for example. Date d9 may be the date on which the fuzzing test was conducted that is included in user setting information d4. Primary determination result d11a is, for example, “FAIL”, secondary determination result d12a is, for example, “FAIL”, and overall result d13a is, for example, “Critical”. It should be noted that overall result d13a is an overall determination result that is indicated in overall determination result information d13. Determination reason d14 is a response from the generative AI, and in other words, is a determination reason that is included in secondary determination result information d12. It should be noted that determination reason d14 may include a plurality of determination reasons. Furthermore, determination reason d14 may include an above-mentioned applicable location that corresponds to the determination reason.

For example, outputter 18 obtains setting information d22 from preprocessor 13, and generates title d7, outline d8, user setting information d4a, and date d9 based on user setting information d4 included in setting information d22. Furthermore, for example, outputter 18 obtains primary determination result information d11 from primary analyzer 15, obtains secondary determination result information d12 from secondary analyzer 16, and generates primary determination result d11a, secondary determination result d12a, and determination reason d14 based on the information obtained. Furthermore, outputter 18 obtains overall determination result information d13 from overall determiner 17, and generates overall result d13a based on overall determination result information d13. Furthermore, outputter 18 generates determination result report d31 by joining together title d7, outline d8, user setting information d4a, date d9, primary determination result d11a, secondary determination result d12a, overall result d13a, and determination reason d14.

It should be noted that in the example in FIG. 6, although determination result report d31 includes title d7, outline d8, user setting information d4a, date d9, primary determination result d11a, secondary determination result d12a, overall result d13a, and determination reason d14, determination result report d31 need not include all of these items. In other words, determination result report d31 need only include overall result d13a. Furthermore, determination result report d31 may, for example, be of a hypertext markup language (HTML) format.

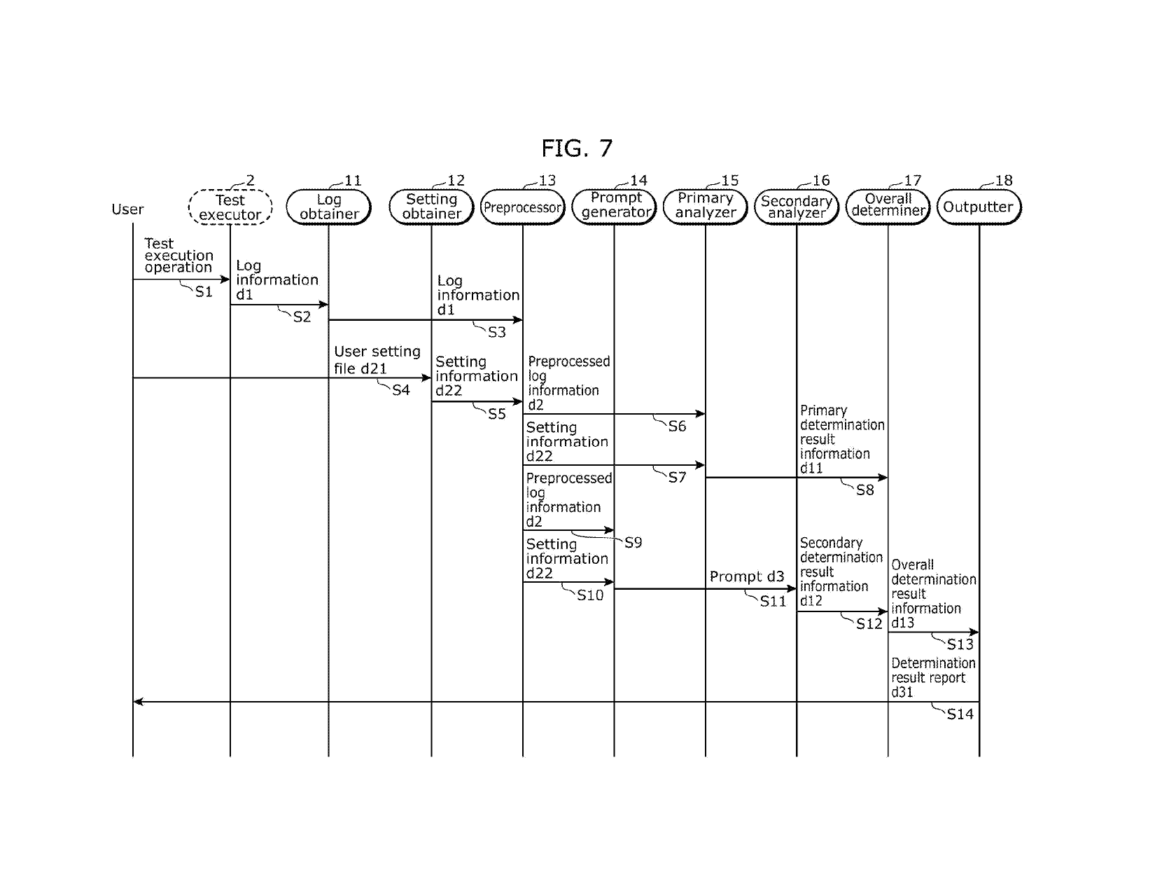

FIG. 7 is a sequence diagram illustrating an example of processing operations of determination system 10 according to the present embodiment.

First, the user performs, on test executor 2, an operation for performing a fuzzing test (i.e., a test execution operation) on evaluation target device 1 (step S1). With this, test executor 2 performs the fuzzing test on evaluation target device 1. Next, test executor 2 outputs log information d1 that indicates the execution status of the fuzzing test to log obtainer 11 (step S2). Once log obtainer 11 obtains log information d1, log obtainer 11 outputs log information d1 to preprocessor 13 (step S3).

Furthermore, setting obtainer 12 obtains user setting file d21 in accordance with the above-mentioned input operation performed by the user on the input device (step S4). Next, setting obtainer 12 generates setting information d22 based on user setting file d21, and outputs setting information d22 to preprocessor 13 (step S5).

Once preprocessor 13 obtains log information d1 and setting information d22 that are output in step S3 and step S5, preprocessing is performed on log information d1 using setting information d22. Next, preprocessor 13 outputs preprocessed log information d2 that is generated in the preprocessing and setting information d22 to primary analyzer 15 (step S6 and step S7).

Once primary analyzer 15 obtains preprocessed log information d2 and setting information d22 that are output in step S6 and step S7, primary analysis is performed on preprocessed log information d2 using setting information d22. Furthermore, primary analyzer 15 generates primary determination result information d11 indicating a result of the primary analysis, and outputs primary determination result information d11 to overall determiner 17 (step S8).

Furthermore, preprocessor 13 outputs preprocessed log information d2 that is generated in the preprocessing and setting information d22 to prompt generator 14 (step S9 and step S10). Prompt generator 14 generates prompt d3 based on preprocessed log information d2 and setting information d22, and outputs prompt d3 to secondary analyzer 16 (step S11).

Secondary analyzer 16 obtains secondary determination result information d12 that is a response from the generative AI by performing secondary analysis using prompt d3 that is output in step S11, and outputs secondary determination result information d12 to overall determiner 17 (step S12).

Overall determiner 17 generates overall determination result information d13 that indicates an overall determination result for the fuzzing test based on primary determination result information d11 and secondary determination result information d12 output in step S8 and step S12. Next, overall determiner 17 outputs overall determination result information d13 to outputter 18 (step S13). Outputter 18 generates and outputs determination result report d31 that includes the determination result that is indicated by overall determination result information d13 output in step S13 (step S14).

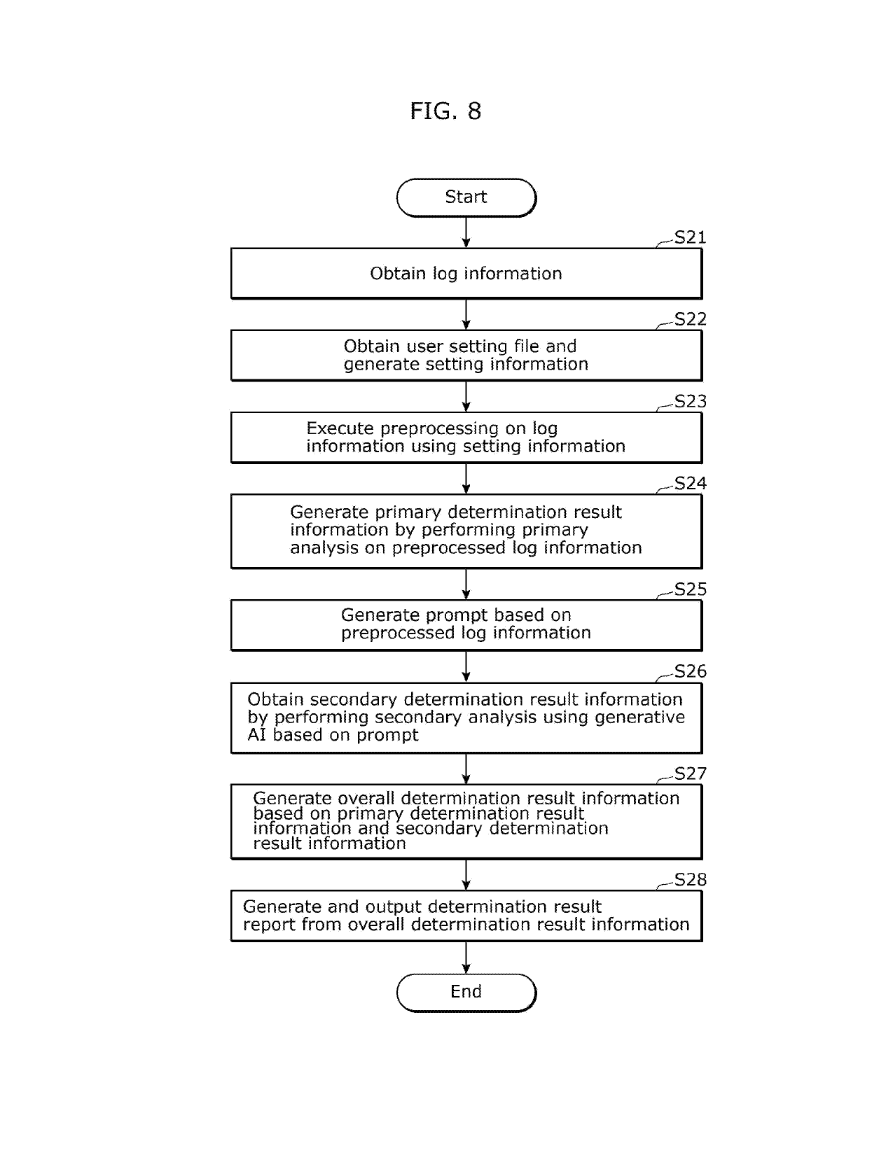

FIG. 8 is a flowchart illustrating an example of processing operations of determination system 10 according to the present embodiment.

First, log obtainer 11 of determination system 10 obtains log information d1 from test executor 2 (step S21). Next, setting obtainer 12 obtains user setting file d21 in accordance with the input operation performed by the user, and generates setting information d22 (step S22).

Next, preprocessor 13 performs preprocessing on log information d1 using setting information d22 (step S23). Next, primary analyzer 15 generates primary determination result information d11 by performing primary analysis, using setting information d22, on preprocessed log information d2 that is generated in the preprocessing (step S24).

Next, prompt generator 14 generates prompt d3 based on preprocessed log information d2 that is generated in the preprocessing (step S25). Here, prompt generator 14 uses setting information d22 in the generation of prompt d3. Next, secondary analyzer 16 obtains secondary determination result information d12 by performing secondary analysis using the generative AI based on the response provided to prompt d3 (step S26).

Next, overall determiner 17 generates overall determination result information d13 based on primary determination result information d11 generated in step S24 and secondary determination result information d12 obtained in step S26 (step S27). Next, outputter 18 generates and outputs determination result report d31 from overall determination result information d13 that is generated (step S28).

As described above, in the present embodiment, primary determination result information d11 that indicates an accurate determination result can be generated by performing primary analysis, and it is also possible to achieve a sophisticated level of analysis and to generate secondary determination result information d12 that indicates a determination result that is highly accurate by performing secondary analysis. Furthermore, in the present embodiment, determination result report d31 is output that includes an overall determination result of a fuzzing test that is based on results of primary analysis and secondary analysis. Consequently, it is possible to enhance the accuracy and reliability of a determination result included in determination result report d31 to be higher than that of a determination result for primary analysis, for error words and the like, and higher than that of a determination result for secondary analysis using generative AI, for example. Furthermore, since log information d1 is used, it is possible to increase the likelihood of effectively identifying and preventing potential failures that are related to the security of evaluation target device 1. Furthermore, since determination result report d31 is automatically output and determination result report d31 can be promptly output, it is possible to reduce the amount of man-hours needed to determine the results of a fuzzing test. Furthermore, even for a user who lacks specialized knowledge, the user can easily grasp the content of a determination result of a fuzzing test by looking at determination result report d31. Furthermore, since generative AI is used to determine a result of a fuzzing test, it is possible to reduce the degree of necessity to perform machine learning that corresponds to evaluation target device 1 in advance of the fuzzing test, thereby allowing a determination result of the fuzzing test to be obtained in an efficient manner. Consequently, in the present embodiment, the result of the fuzzing test of evaluation target device 1 can be properly determined.

Furthermore, in the present embodiment, by performing preprocessing, characters, such as garbled or corrupted text included in log information d1 is deleted, and characters, such as those that are susceptible to being misidentified are converted into characters that are not susceptible to being misidentified, for example. Since preprocessed log information d2 that is generated in such preprocessing is used in each of the processes performed by primary analyzer 15, prompt generator 14, and the generative AI, it is possible to reduce the possibility of such processes being executed in an improper manner. Furthermore, when a word, such as one that is equivalent to confidential information is converted to a different word, it is possible to protect such confidential information and privacy in general. Furthermore, when the character count is being limited through the deletion of characters and the like, it is possible to reduce the processing burden placed on primary analyzer 15, prompt generator 14, the generative AI, and the like.

Furthermore, in the present embodiment, since portions that are important for determining a result of a fuzzing test are extracted from log information d1 and included in preprocessed log information d2, by preprocessing, it is possible to reduce the processing burden placed on primary analyzer 15 and prompt generator 14, which use preprocessed log information d2, as well as the generative AI and the like.

Furthermore, in the present embodiment, only those portions that correspond to a specified period of time are extracted from log information d1 and included in preprocessed log information d2, by preprocessing. Consequently, it is possible to reduce the processing burden placed on primary analyzer 15 and prompt generator 14, which use preprocessed log information d2, as well as the generative AI and the like.

Furthermore, in the present embodiment, primary analyzer 15 generates primary determination result information d11 by searching preprocessed log information d2 for an error word indicated in setting information d22. Consequently, it is possible to generate primary determination result information d11 that indicates a proper determination result of a fuzzing test.

Although determination system 10 and a determination method according to one or more aspects of the present disclosure have been described on the basis of the foregoing embodiment, the present disclosure is not limited to the embodiment. The present disclosure may include forms obtained by various modifications to the foregoing embodiment that can be conceived by those skilled in the art, for as long as they do not depart from the essence of the present disclosure.

For example, log information d1 may include information that is output from evaluation target device 1, and may include information that is generated by test executor 2. In other words, as long as the information is information that is generated and output for a fuzzing test, log information d1 may include any kind of information, and log information d1 may include information that is generated and output by a network device.

Furthermore, in the present embodiment, while the generative AI is not included in determination system 10, the generative AI may be included in determination system 10. Furthermore, the generative AI may be deployed on a cloud server connected to determination system 10 via a communication network, and may be deployed on the same computer (personal computer, for example) as determination system 10.

Furthermore, prompt generator 14 may generate a plurality of prompts d3 for one preprocessed log information d2, and secondary analyzer 16 may input the plurality of prompts to the generative AI. In this case, the one preprocessed log information d2 is divided into a plurality of information items, and each of the plurality of information items may be included in a corresponding one of the plurality of prompts d3. Accordingly, it is possible to easily restrict the character count or data volume related to preprocessed log information d2 included in one of prompts d3 to not exceed a given range.

Furthermore, outputter 18 may customize the format or content of determination result report d31 in accordance with an input operation performed by a user on an input device.

In the above-mentioned embodiment, each element may be configured as dedicated hardware, or may be implemented by executing a software program suitable for each element. The respective elements may be implemented by a program executer such as a central processing unit (CPU) or a processor reading and executing a software program recorded on a recording medium such as a hard disk or a semiconductor memory. Here, the software that implements determination system 10 and the like according to the above-mentioned embodiment is a computer program that causes a computer to execute each step indicated in the flowchart in FIG. 8, for example.

Furthermore, the present disclosure also includes the following cases.

(1) More specifically, at least one of the preceding systems or devices may be a computer system configured with a microprocessor, read-only memory (ROM), random-access memory (RAM), a hard disk unit, a display unit, a keyboard, a mouse, or the like. The RAM or the hard disk unit stores a computer program. The microprocessor operates according to the computer program, so that a function of the at least one preceding device is achieved. Here, the computer program includes a plurality of pieced together instruction codes indicating instructions to be given to the computer so as to achieve a specific function.

(2) Some or all of the elements included in the at least one preceding system or device may be realized in a single system large-scale integration (LSI). The system LSI is a super multifunctional LSI manufactured by integrating a plurality of elements onto a single chip. To be more specific, the system LSI is a computer system configured with a microprocessor, a ROM, a RAM, or the like, for example. The RAM stores a computer program. The microprocessor operates according to the computer program, so that a function of the system LSI is achieved.

(3) Some or all of the elements included in the at least one preceding system or device may be realized in an IC card or stand-alone module that can be inserted and removed from the device. The IC card or the module is a computer system that includes a microprocessor, a ROM, a RAM, and the like. The IC card or the module may include the super-multifunctional LSI described above. The microprocessor operates according to the computer program, so that a function of the IC card or the module is achieved. The IC card or the module may be tamper-resistant.

(4) The present disclosure may be the method described above. Furthermore, the present disclosure may be a computer program for causing a computer to execute the method, or may be a digital signal of a computer program.

Additionally, the present disclosure may be a computer program or a digital signal recorded on a computer-readable recording medium, such as a flexible disk, a hard disk, a compact disc (CD)-ROM, a digital video disc (DVD), a DVD-ROM, a DVD-RAM, a BD (Blu-ray Disc (registered trademark)), or a semiconductor memory. Moreover, the present disclosure may be implemented as the digital signal recorded on the above-mentioned recording media.

Furthermore, the present disclosure may be the above-mentioned computer program or the digital signal transmitted via an electric communication line, a wireless or wired communication line, a network, such as the Internet, data broadcasting, and the like.

Moreover, by transferring the recording medium having the above-mentioned program or digital signal recorded thereon or by transferring the above-mentioned program or digital signal via the above-mentioned network or the like, the present disclosure may be implemented by a different independent computer system.

While an embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in its entirety: Japanese Patent Application No. 2025-007190 filed on January 17, 2025.

### Industrial Applicablity

The determination system according to the present disclosure can be applied to a device or a system or the like that assists in determining a result of a security test performed on an ECU or the like installed in a vehicle or the like, for example.

1. A determination system comprising:
a processor; and
a memory connected to the processor, wherein
using the memory, the processor:
obtains log information indicating an execution status of a security test performed on an evaluation target device;
obtains a user setting file that is set by a user, and outputs setting information based on the user setting file;
generates preprocessed log information by performing an edit on the log information as preprocessing;
generates primary determination result information indicating a determination result of the security test by performing primary analysis on the preprocessed log information using the setting information;
generates, based on the setting information and the preprocessed log information, a prompt that prompts generative artificial intelligence (AI) to output a determination result of the security test;
performs, as secondary analysis, a process of obtaining secondary determination result information indicating a determination result of the security test by inputting the prompt to the generative AI;
generates overall determination result information indicating an overall determination result of the security test, based on the determination result indicated by the primary determination result information and the determination result indicated by the secondary determination result information; and
outputs a determination result report that includes the overall determination result indicated by the overall determination result information.

2. The determination system according to claim 1, wherein
the preprocessing includes deleting or converting at least one of a character, a word, or a row included in the log information.

3. The determination system according to claim 1, wherein
the preprocessing includes a process of detecting, in the log information, a word indicated in the setting information, and extracting, from the log information, a portion consisting of a plurality of consecutive rows and including the word detected.

4. The determination system according to claim 1, wherein
the preprocessing includes a process of extracting, from the log information, only a portion of information that is output within a specified period of time during the security test.

5. The determination system according to claim 1, wherein
in the primary analysis, the processor generates the primary determination result information by searching the preprocessed log information for an error word indicated in the setting information.

6. A determination method executed by a computer, the determination method comprising:
obtaining log information indicating an execution status of a security test performed on an evaluation target device;
obtaining a user setting file that is set by a user, and outputting setting information based on the user setting file;
generating preprocessed log information by performing an edit on the log information as preprocessing;
generating primary determination result information indicating a determination result of the security test by performing primary analysis on the preprocessed log information using the setting information;
generating, based on the setting information and the preprocessed log information, a prompt that prompts generative artificial intelligence (AI) to output a determination result of the security test;
performing, as secondary analysis, a process of obtaining secondary determination result information indicating a determination result of the security test by inputting the prompt to the generative AI;
generating overall determination result information indicating an overall determination result of the security test, based on the determination result indicated by the primary determination result information and the determination result indicated by the secondary determination result information; and
outputting a determination result report that includes the overall determination result indicated by the overall determination result information.
